(19) United States
(12) Patent Application Publication
(10) Pub. No.: US 2015/0278995 A1
(43) Pub. Date: Oct. 1, 2015

(54) IMAGE DATA PROCESSING APPARATUS, IMAGE DATA PROCESSING METHOD, IMAGE DISTORTION CORRESPONDING PROCESSING APPARATUS, AND IMAGE DISTORTION CORRESPONDING PROCESSING METHOD

(71) Applicant: SONY CORPORATION, Tokyo (JP)

(72) Inventor: Yuji Nakahata, Tokyo (JP)

(21) Appl. No.: 14/662,422

(22) Filed: Mar. 19, 2015

(30) Foreign Application Priority Data
Mar. 31, 2014 (JP) 2014-072134

(51) Int. Cl. G06T 3/40; H04N 5/232; G06T 9/20; G06T 7/00; G06T 3/20; G06T 1/00

(52) U.S. Cl. CPC G06T 3/4038; G06T 3/20; G06T 1/0007; G06T 9/20; G06T 7/0038; H04N 5/23238; G06T 2207/10016; G06T 2200/32

(57) ABSTRACT

Provided is an image data processing apparatus including: a distortion degree information subsidiary control unit which subsidiarily applies distortion degree information correlating to a degree of distortion of an image of captured image data to the captured image data generated based on a captured image signal acquired by an imaging device; and a recording control unit which performs control so that the captured image data including the subsidiarily applied distortion degree information is recorded in a recording medium.

### CROSS REFERENCE TO RELATED APPLICATIONS

This application claims the benefit of Japanese Priority Patent Application JP 2014-072134 filed Mar. 31, 2014, the entire contents of which are incorporated herein by reference.

### BACKGROUND

The present technology relates to image data processing apparatus and method which perform a process regarding captured image data generated based on a captured image signal obtained by an imaging device, and particularly to a technical field for performing a process regarding captured image data in which distortion of an image is generated. In addition, the present technology relates to a technical field regarding image distortion corresponding processing apparatus and method which perform a process regarding captured image data in which distortion of an image is generated.

Various panels have been provided as a display panel capable of image display.

For example, a flat display panel having a flat display surface and a curved display panel having a curved display surface have been provided. International Publication No. 2009/050812 discloses a curvature variable display panel which can change a curvature (ratio of curve) of a display surface having flexibility.

Meanwhile, for an image as display contents, the improvement of realistic feeling have been achieved with a panoramic image obtained by panoramic synthesis of a plurality of captured images while panning an imaging apparatus or a high-resolution wide-angle image captured by a wide-angle lens using an imaging device with high resolution.

### SUMMARY

Here, the panoramic image or the high-resolution wide-angle image is generally obtained as an image in which a distortion (distortion of shape of a subject) is generated due to a width of an angle of view.

When the image having a distortion generated as described above is displayed on the flat display panel as it is, this may provide feeling of strangeness to an observer. Even in a case where the curved surface display panel is used, when the display panel has a curvature which does not correspond to a degree of a distortion of the image, the realistic feeling may not suitably applied.

It is desirable to perform suitable image display corresponding to a display surface shape of a display panel, when performing image display based on captured image data in which a distortion of an image is generated.

According to an embodiment of the present technology, there is provided an image data processing apparatus including: a distortion degree information subsidiary control unit which subsidiarily applies distortion degree information correlating to a degree of distortion of an image of captured image data to the captured image data generated based on a captured image signal acquired by an imaging device; and a recording control unit which performs control so that the captured image data including the subsidiarily applied distortion degree information is recorded in a recording medium.

In this case, the distortion degree information is subsidiarily applied to the captured image data in which the distortion of the image is generated, such as panoramic image data or wide-angle captured image data, for example, and is stored in a desired recording medium.

In the image data processing apparatus according to the embodiment of the present technology, it is desirable that the image data processing apparatus further include a panoramic synthesis processing unit which performs panoramic synthesis of the plurality of captured image data items acquired by performing imaging in directions different from each other and generates panoramic image data, and the distortion degree information subsidiary control unit generates the distortion degree information based on an imaging direction maximum difference angle which is an angle of a difference between one end side captured image data and the other end side captured image data in an imaging direction having the maximum difference between angles in the moving direction among the plurality of captured image data items, and subsidiarily apply the generated distortion degree information to the captured image data as the panoramic image data.

In this case, the distortion degree information appropriately correlating to the degree of the distortion of the image of the panoramic image data is subsidiarily applied to the panoramic image data.

In the image data processing apparatus according to the embodiment of the present technology, it is desirable that the distortion degree information subsidiary control unit generate the distortion degree information based on the imaging direction maximum difference angle and angles of the one end side captured image data and the other end side captured image data.

In this case, the distortion degree information more appropriately correlating to the degree of the distortion of the image of the panoramic image data is subsidiarily applied to the panoramic image data.

In the image data processing apparatus according to the embodiment of the present technology, it is desirable that the panoramic synthesis processing unit synthesize the plurality of captured image data items acquired by swing panoramic imaging and generate the panoramic image data.

In this case, it is not necessary to use the plurality of imaging apparatuses for generating the panoramic image data.

In the image data processing apparatus according to the embodiment of the present technology, it is desirable that the distortion degree information subsidiary control unit calculate the imaging direction maximum difference angle based on panoramic imaging duration which is duration from the start to the end of the swing panoramic imaging and an average angular velocity of a swing operation of the swing panoramic imaging.

In this case, the imaging direction maximum difference angle in a case of generating the panoramic image data by the swing panoramic imaging is appropriately acquired.

In the image data processing apparatus according to the embodiment of the present technology, it is desirable that the panoramic synthesis processing unit synthesize the plurality of captured image data items imaged by a plurality of imaging apparatuses which perform the imaging in directions different from each other and generate the panoramic image data.

In this case, it is possible to obtain the plurality of captured image data items necessary for the generation of the panoramic image data at the same time.

In the image data processing apparatus according to the embodiment of the present technology, it is desirable that the distortion degree information subsidiary control unit calculate the imaging direction maximum difference angle based on detection information of a magnetic sensor provided in the one end side imaging apparatus and the other end side imaging apparatus having the maximum difference between angles in the imaging direction among the plurality of imaging apparatuses.

In this case, the imaging direction maximum difference angle in a case of acquiring the panoramic image data by synthesizing the captured image data by the plurality of the imaging apparatuses is appropriately acquired.

In the image data processing apparatus according to the embodiment of the present technology, it is desirable that the distortion degree information subsidiary control unit subsidiarily apply information of an angle of view calculated based on a focal length of a lens unit used in the imaging for acquiring the captured image data and a size of the imaging device, to the captured image data as the distortion degree information.

In this case, the distortion degree information appropriately correlating to the degree of the distortion of the image of the captured image data is subsidiarily applied to the captured image data, in response to a case where the captured image data in which the distortion of the image is generated, is the captured image data acquired by the imaging through the wide-angle lens unit.

According to another embodiment of the present technology, there is provided an image data processing method including: subsidiarily applying distortion degree information correlating to a degree of distortion of an image of captured image data to the captured image data generated based on a captured image signal acquired by an imaging device; and performing control so that the captured image data including the subsidiarily applied distortion degree information is recorded in a recording medium.

In this case, in the same manner as in the image data processing apparatus according to the embodiment of the present technology, the distortion degree information is subsidiarily applied to the captured image data in which the distortion of the image is generated, such as panoramic image data or wide-angle captured image data, for example, and is stored in a desired recording medium.

According to still another embodiment of the present technology, there is provided an image distortion corresponding processing apparatus including: an image acquisition unit which acquires captured image data generated based on a captured image signal acquired by an imaging device, that is, the captured image data to which distortion degree information correlating to a degree of distortion of an image of the captured image data is subsidiarily applied; and an image distortion corresponding processing unit which performs control so that any one of a distortion correction process of the captured image data and curvature adjustment of a curvature variable display panel in which a curvature of a display surface is variable, based on the distortion degree information.

In this case, by performing any one of the distortion correction process and the curvature adjustment of the curvature variable display panel based on the distortion degree information, it is possible to appropriately apply realistic feeling without applying strangeness to an observer, in response to a case of displaying the image based on the captured image data in which the distortion of the image is generated, on a curvature fixed display panel in which a curvature of a display surface is fixed or the curvature variable display panel.

In the image distortion corresponding processing apparatus according to the embodiment of the present technology, it is desirable that the image distortion corresponding processing unit include a first display control unit which performs control so as to execute a distortion correction process of the captured image data based on the distortion degree information, and perform control so as to display an image based on the captured image data subjected to the distortion correction process on a display panel in which a curvature of a display surface is fixed.

In this case, it is possible to appropriately apply realistic feeling without applying strangeness to an observer, in response to a case of displaying the image based on the captured image data in which the distortion of the image is generated, on a curvature fixed display panel in which a curvature of a display surface is fixed.

In the image distortion corresponding processing apparatus according to the embodiment of the present technology, it is desirable that the image distortion corresponding processing unit include a second display control unit which performs control so as to perform curvature adjustment of the curvature variable display panel based on the distortion degree information, and perform control so as to display an image based on the captured image data on the curvature variable display panel.

In this case, it is possible to appropriately apply realistic feeling without applying strangeness to an observer, in response to a case of displaying the image based on the captured image data in which the distortion of the image is generated, on the curvature variable display panel.

In the image distortion corresponding processing apparatus according to the embodiment of the present technology, it is desirable that the image distortion corresponding processing unit include a third display control unit which performs control so as to perform the distortion correction process according to a difference between a degree of distortion shown by the distortion degree information and a degree of distortion corresponding to a curvature of the curvature variable display panel, and perform control so as to display an image based on the captured image data subjected to the distortion correction process on the curvature variable display panel.

In this case, an image having the distortion corresponding to the current set curvature of the display panel is displayed on the curvature variable display panel.

According to still another embodiment of the present technology, there is provided an image distortion corresponding processing method including: acquiring captured image data generated based on a captured image signal acquired by an imaging device, that is, the captured image data to which distortion degree information correlating to a degree of distortion of an image of the captured image data is subsidiarily applied; and performing control so that any one of a distortion correction process of the captured image data and curvature adjustment of a curvature variable display panel in which a curvature of a display surface is variable, based on the distortion degree information.

In this case, in the same manner as in the image distortion corresponding processing apparatus according to the embodiment of the present technology, it is possible to appropriately apply realistic feeling without applying strangeness to an observer, in response to a case of displaying the image based on the captured image data in which the distortion of the image is generated, on a curvature fixed display panel in which a curvature of a display surface is fixed or the curvature variable display panel.

According to the present technology, it is possible to perform the appropriate image display corresponding to the display surface shape of the display panel, in a case of performing the image display based on the captured image data in which the distortion of the image is generated.

The effects disclosed herein are not limited, and any other effects disclosed in this specification may be acquired.

### BRIEF DESCRIPTION OF THE DRAWINGS

FIG. 1 is an explanatory diagram of an outline of an image display system of a first embodiment;

FIG. 2 is a diagram showing an example of the panoramic image;

FIGS. 3A and 3B are explanatory diagrams of swing panoramic imaging;

FIG. 4A is an example of seams and FIG. 4B is a schematic view of the panoramic image obtained by joining along seams;

FIG. 5 is a block diagram showing an inner hardware configuration of an image data processing apparatus (imaging apparatus) of the first embodiment;

FIG. 6 is an explanatory diagram of an angle of view of panoramic image data;

FIG. 7 is a flowchart showing a procedure of a process executed in the image data processing apparatus of the first embodiment;

FIG. 8 is a block diagram showing an inner hardware configuration of an image distortion corresponding processing apparatus (display apparatus) which corresponds to a configuration and processing example I;

FIG. 9 is a diagram showing display of an image on a flat display panel based on panoramic image data which is subjected to a distortion correction process;

FIG. 10 is a diagram showing an image when an image subjected to a distortion correction process according to a difference between distortion degree information and a distortion degree corresponding to a curvature of a display panel is displayed on a curved display panel;

FIG. 11 is a block diagram showing an inner hardware configuration of an image distortion corresponding processing apparatus (display apparatus) which corresponds to a configuration and processing example II;

FIG. 12 is a flowchart showing a procedure of a process executed in an image distortion corresponding processing apparatus which corresponds to a configuration and processing example II;

FIG. 13 is a flowchart showing a procedure of a process executed in an image distortion corresponding processing apparatus which corresponds to a configuration and processing example III;

FIG. 14 is an explanatory diagram of an outline of an image display system of a second embodiment;

FIG. 15 is a block diagram showing respective inner hardware configurations of an imaging apparatus and a panoramic image generation apparatus (image data processing apparatus of a second embodiment) included in an image display system of the second embodiment;

FIG. 16 is a flowchart showing a specific process procedure for realizing subsidiary control of distortion degree information and recording control as the second embodiment;

FIG. 17 is a block diagram showing an inner hardware configuration of an image data processing apparatus of a third embodiment; and

FIG. 18 is a flowchart showing a procedure of a process executed in an image data processing apparatus of the third embodiment.

### DETAILED DESCRIPTION OF EMBODIMENTS

Hereinafter, the embodiments will be described in the following order.

### 1. First Embodiment

### 1-1. Outline of Image Display System

### 1-2. Configuration of Image Data Processing Apparatus

### 1-3. Subsidiary Control of Distortion Degree Information and Recording Control

### 1-4. Process Procedure

### 1-5. Image Distortion Corresponding Processing Apparatus

### Configuration and Processing Example I

### Configuration and Processing Example II

### Configuration and Processing Example III

### 2. Second Embodiment

### 2-1. Outline of Image Display System

### 2-2. Configuration of Image Data Processing Apparatus

### 2-3. Subsidiary Control of Distortion Degree Information and Recording Control

### 2-4. Process Procedure

### 3. Third Embodiment

### 3-1. Configuration of Image Data Processing Apparatus

### 3-2. Process Procedure

### 4. Conclusion of Embodiments

### 5. Modification Example

### 6. Present Technology

### 1. First Embodiment

### 1-1. Outline of Image Display System

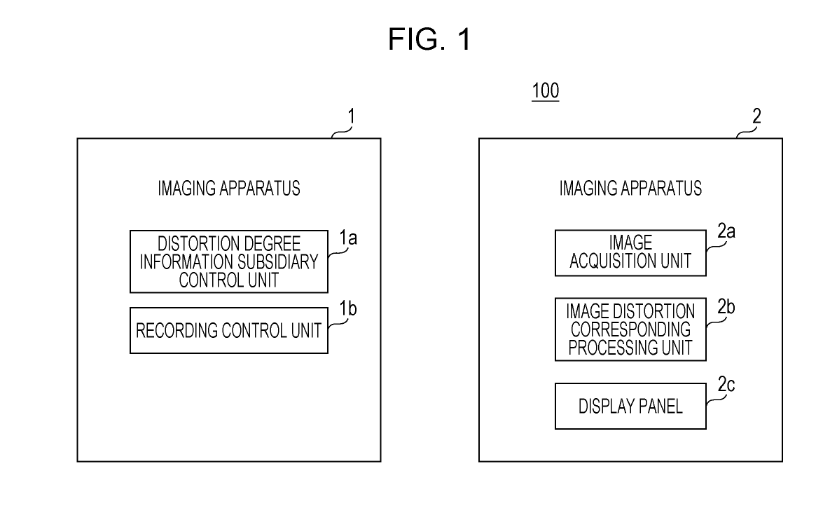

FIG. 1 is an explanatory diagram of an outline of an image display system 100 of a first embodiment.

The image display system 100 at least includes an imaging apparatus 1 and a display apparatus 2.

The imaging apparatus 1 is one embodiment of an image data processing apparatus of the present technology and the display apparatus 2 is one embodiment of an image distortion corresponding processing apparatus of the present technology.

The imaging apparatus 1 is a digital still camera including an imaging device (imaging device 11 which will be described later) such as a charge coupled device (CCD) image sensor or a complementary metal oxide semiconductor (CMOS) image sensor, and generates captured image data based on a captured image signal obtained by the imaging device. The imaging apparatus 1 has a function of generating captured image data as so-called panoramic image data, as the captured image data.

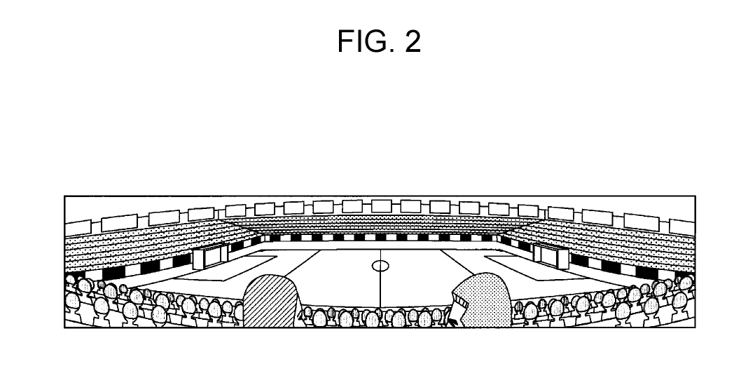

The panoramic image data is captured image data generated by panoramic synthesis of a plurality of captured image data items obtained by being imaged in different directions, and has comparatively wide angles of view, as shown in FIG. 2.

In a case of the first embodiment, the panoramic image data is generated by so-called swing panoramic imaging.

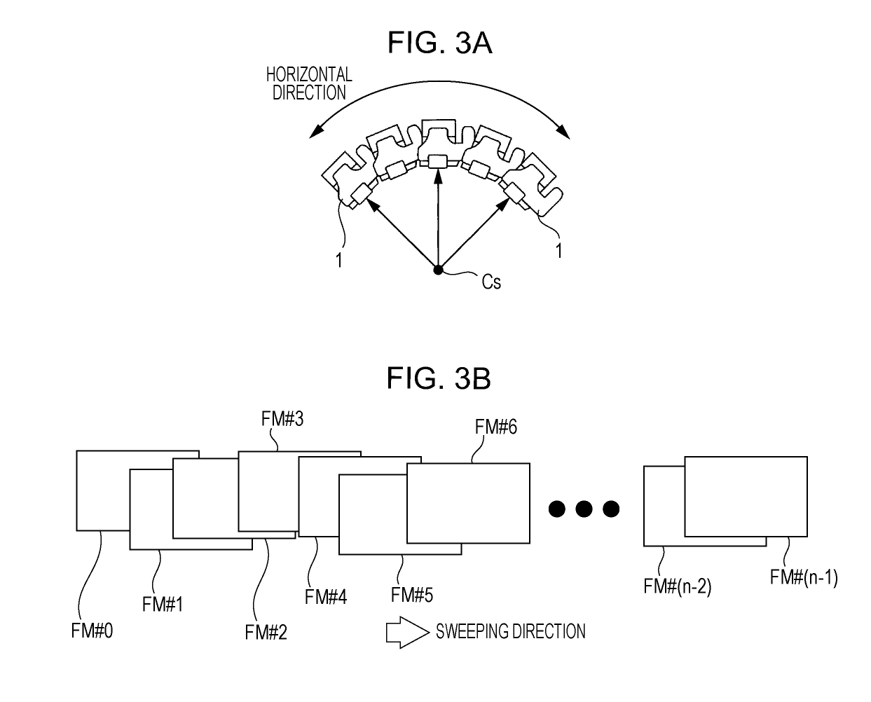

FIGS. 3A and 3B are explanatory diagrams of the swing panoramic imaging, in which FIG. 3A shows a motion of the imaging apparatus 1 when performing swing panoramic imaging and FIG. 3B schematically shows the plurality of captured image data items obtained during the swinging.

The swing panoramic imaging means imaging performed by a photographer by imaging the plurality of captured image data items (still image data) by the imaging apparatus 1 while rotating the imaging apparatus 1 at a spot (rotation shaft) Cs.

Hereinafter, the rotation movement of the imaging apparatus 1 when performing the swing panoramic imaging is referred to as “sweeping”.

The plurality of (set as n) captured image data items obtained by the imaging during the sweeping are referred to as “panoramic frame image data FM” and each of the panoramic frame image data items FM is distinguished by applying numbers (0 to (n−1)) corresponding to the imaging order with “#”.

As shown in FIG. 3B, when generating the panoramic image data, the n panoramic frame image data items FM#0 to FM#(n−1) obtained during the sweeping are appropriately positioned. As shown in FIG. 3B, as a result of the positioning of the panoramic frame image data items FM, generally, not only a sweeping direction, but slight movement in a direction orthogonal to the sweeping direction may be recognized. This is a deviation generated due to camera shake of a photographer during the sweeping.

After performing the positioning as shown in FIG. 3B, a synthesis process is performed regarding the panoramic frame image data items FM#0 to FM#(n−1) as follows.

First, as shown in FIG. 3B, since each of the captured frame image data items FM has a portion overlapped with the adjacent to the frame image data item FM, areas to be used for a final panoramic image is determined from each frame image data FM by considering the overlapped portions. That is the same operation as determination of joints of images of the panoramic synthesis process (hereinafter referred to as “seams SM”).

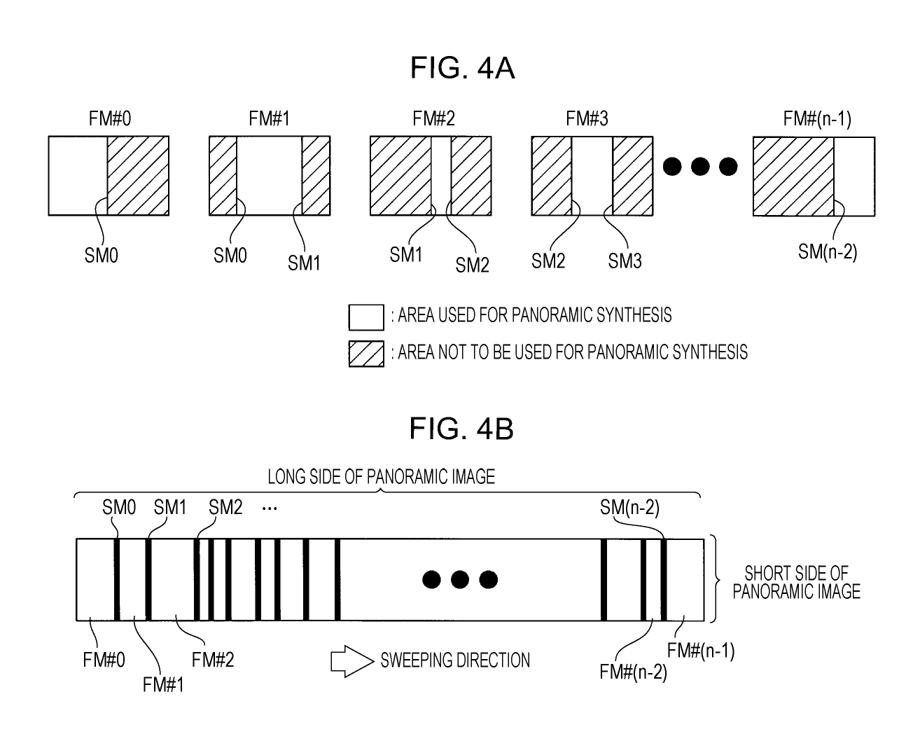

FIG. 4A shows an example of seams SM.

The seams SM may be straight lines orthogonal to the sweeping direction, as shown in FIG. 4A. The seams SM are not limited to the straight lines and may be non-linear (curve or the like).

In FIG. 4A, the seam SM0 is shown as a joint between the panoramic frame image data items FM#0 and FM#1, the seam SM1 is shown as a joint between the panoramic frame image data items FM#1 and FM#2, . . . and the seam SM(n−2) is shown as a joint between the panoramic frame image data items FM#(n−2) and FM#(n−1).

Since the seams SM0 to SM(n−2) are used as joints between the adjacent images when performing the synthesis, the shaded portions in each of the frame image data items FM are set as image areas not used in the final panoramic image.

The synthesis of the panoramic frame image data items FM#0 to FM#(n−1) is performed based on the seams SM0 to SM(n−2) determined as described above, but a blending process may also be performed regarding image areas near the seams SM, in order to decrease artificiality of the image near the seams SM.

That is, the image areas near the seams SM of the frame image data items FM which are in an adjacency relationship are blended with each other and joined along the seams SM.

The blending process is not compulsory and may be omitted.

As described above, the seams SM of the frame image data items FM are determined, the joining of boundary areas or the joining by the blending process is performed, and the unnecessary portions in the direction orthogonal to the sweeping direction is finally trimmed by considering an amount of the camera shaking, and accordingly, it is possible to obtain panoramic image data having the sweeping direction as a long side direction and a wide angle of view, as shown in FIG. 4B.

In FIG. 4B, vertical lines show the seams SM and the drawing schematically shows the state in which the n panoramic frame image data items FM#0 to FM#(n−1) are joined with each other by the seams SM0 to SM(n−2) and the panoramic image data is generated.

The description will be performed by returning to FIG. 1.

In the imaging apparatus 1 of the embodiment, the panoramic image data generated by performing the sweeping panoramic imaging described above is obtained. In the panoramic image data, generation of a distortion of the image (distortion of a shape of a subject projected in an image) is not avoidable due to a width of the angle of view.

The imaging apparatus 1 has functions shown as a distortion degree information subsidiary control unit 1a and a recording control unit 1b in FIG. 1, in response to the generation of the panoramic image data in which a distortion of an image is generated as described above.

The distortion degree information subsidiary control unit 1a applies distortion degree information Ds correlating to the degree of the distortion of the image of the captured image data subsidiarily to the captured image data in which the image distortion is generated as the panoramic image data.

The recording control unit 1b controls so that the captured image data including the subsidiarily applied distortion degree information Ds is recorded in a recording medium. As will be described later, the imaging apparatus 1 is provided with a recording and reproduction device 15 and can record the captured image data in a necessary recording medium.

A specific method of acquiring the distortion degree information Ds or a specific configuration for realizing the functions as the distortion degree information subsidiary control unit 1a and the recording control unit 1b will be described later.

The display apparatus 2 includes a display panel 2c which can perform image display and accordingly, the display apparatus can perform the image display based on the captured image data recorded by the recording control unit 1b of the imaging apparatus 1.

The display apparatus 2 has functions shown as an image acquisition unit 2a and an image distortion corresponding processing unit 2b in the drawing.

The function as the image acquisition unit 2a is a function of acquiring the captured image data including the subsidiarily applied the distortion degree information Ds.

Here, various methods of causing the display apparatus 2 to acquire the captured image data from the imaging apparatus 1 side are considered.

For example, when the imaging apparatus 1 records the captured imaging data in a removable medium such as a memory card, the display apparatus 2 may read the captured image data from the mounted removable medium and acquire the captured image data. Alternatively, it is also possible to cause the display apparatus 2 to acquire the captured image data by connecting the imaging apparatus 1 and the display apparatus 2 to each other through wired connection such as a universal serial bus (USB) cable, wireless connection, or a network such as the Internet.

In addition, the captured image data obtained by the imaging apparatus 1 may be temporarily transmitted to an apparatus other than the imaging apparatus 1 and the display apparatus 2 and the captured image data may be transmitted from the other apparatus to the display apparatus 2. In this case, the other apparatus may be a server apparatus connected to a necessary network such as the Internet, and the display apparatus 2 in this case may access the server apparatus through a network and acquire the captured image data.

The image distortion corresponding processing unit 2b performs control so that any one of a distortion correction process of the captured image data and curvature adjustment of the display panel 2c as a curvature variable display panel in which a curvature of a display surface is variable, is performed based on the distortion degree information Ds.

It is possible to realize the appropriate image display performed according to the display surface shape of the display panel 2c, by the function as the image distortion corresponding processing unit 2b.

A specific configuration for realizing the functions as the image acquisition unit 2a and the image distortion corresponding processing unit 2b will be described later.

### 1-2. Configuration of Image Data Processing Apparatus

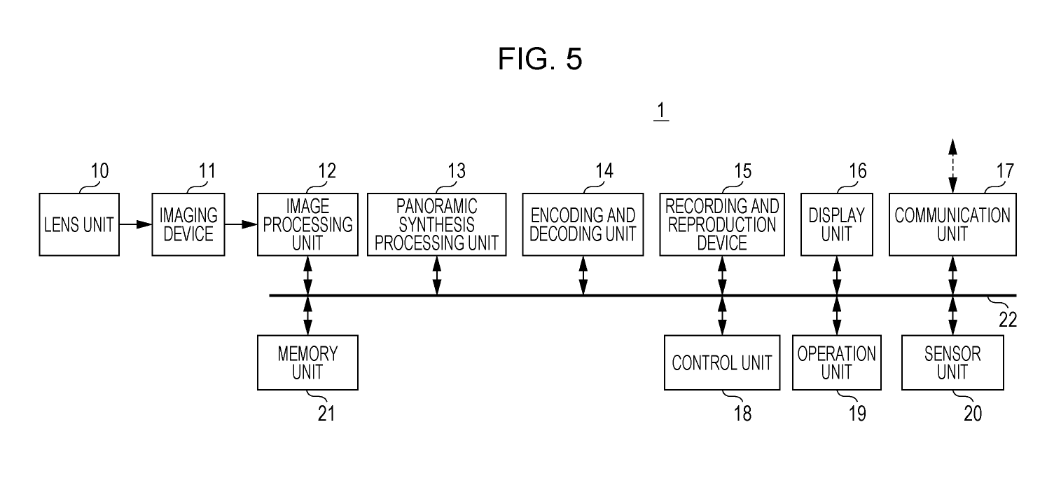

FIG. 5 is a block diagram showing an inner hardware configuration of the imaging apparatus 1.

The imaging apparatus 1 includes a lens unit 10, an imaging device 11, an image processing unit 12, a panoramic synthesis processing unit 13, an encoding and decoding unit 14, a recording and reproduction device 15, a display unit 16, a communication unit 17, a control unit 18, an operation unit 19, a sensor unit 20, a memory unit 21, and a bus 22. As shown in the drawing, the image processing unit 12, the panoramic synthesis processing unit 13, the encoding and decoding unit 14, the recording and reproduction device 15, the display unit 16, the communication unit 17, the control unit 18, the operation unit 19, the sensor unit 20, and the memory unit 21 are connected to each other through the bus 22 and transmit and receive the image data or a control signal to and from each other.

The lens unit 10 collects light from a subject and performs imaging on an imaging surface of the imaging device 11. The lens unit 10 has a function of adjusting a focal length, a subject distance, or a diaphragm according to an instruction from the control unit 18, so as to acquire an appropriate image. The lens unit 10 may also have a camera shake correction mechanism for optically preventing a blur of an image.

The imaging device 11 is, for example, configured with a CCD image sensor or a CMOS image sensor, receives light based on a subject image imaged by the lens unit 10 and performs photoelectric conversion to convert the light into an electrical signal (captured image signal).

The image processing unit 12 is configured with a sampling circuit which samples the electrical signal from the imaging device 11, an A/D conversion circuit which converts an analog signal into a digital signal, and an image processing circuit which performs a predetermined image processing with respect to the digital signal. The image processing unit 12 performs a process of acquiring image data (captured image data) based on the captured signal obtained by the imaging device 11. As the captured image data, the still image data used as the panoramic frame image data FM and moving image data may be generated.

The captured image data obtained by the image processing unit 12 is temporarily stored (recorded) in the memory unit 21.

The panoramic synthesis processing unit 13 performs a panoramic synthesis process for realizing the panoramic synthesis described above, based on an instruction from the control unit 18.

Specifically, the panoramic image data is generated by performing the positioning shown in FIG. 3B, the determination of the seams SM0 to SM(n−2), the joining along the seams SM, and the trimming of the image after the joining, with respect to the n panoramic frame image data items FM#0 to FM#(n−1) acquired during the sweeping panoramic imaging.

The image processing unit 12 or the panoramic synthesis processing unit 13 may be realized not only with a dedicated hardware circuit, but also with a software process performed by a central processing unit (CPU) or a digital signal processor (DSP) for corresponding the flexible image processing.

The encoding and decoding unit 14 performs an encoding process regarding the captured image data and a decoding process regarding the encoded captured image data, based on an instruction from the control unit 18.

For example, in a case of the imaging of a still image, the encoding and decoding unit 14 encodes the captured image data acquired by the image processing unit 12 and temporarily stored in the memory unit 21 with a predetermined still image compression format such as Joint Photographic Experts Group (JPEG) and generates an image file as a still image file. In a case of the imaging of a moving image, the encoding and decoding unit performs the encoding with a predetermined moving image compression format such as Advanced Video Codec High Definition (AVCHD), for example, based on the captured image data acquired by the image processing unit 12 and temporarily stored in the memory unit 21, and generates an image file as a moving image file.

The encoding and decoding unit 14 decodes the image files obtained by the predetermined still image format and moving image format.

The recording and reproduction device 15 is configured with recording and reproduction circuit and mechanism of a recording medium such as a memory card (card-type memory apparatus) including a semiconductor memory such as a flash memory or a removable medium such as a magnetic disc, an optical disc, or a magnetooptical disc.

The recording and reproduction device 15 records the image files acquired by the encoding process performed by the encoding and decoding unit 14 and various data items in a recording medium, based on an instruction from the control unit 18. The recording and reproduction device 15 reproduces the image files and the various data items recorded in the recording medium, based on an instruction from the control unit 18.

The recording and reproduction device 15 may perform the recording and reproduction with respect to a recording medium embedded in the imaging apparatus 1.

The display unit 16 includes a display capable of image display such as a liquid crystal display (LCD) or an organic electroluminescence (EL) display, and performs display of various information items such as the image based on an instruction from the control unit 18.

For example, the display unit 16 displays the image based on the captured image data acquired by the decoding process performed by the encoding and decoding unit 14. In addition, the display unit 16 displays the image based on the captured image data acquired by the image signal processing unit 12 as a so-called through image.

The communication unit 17 performs communication or network communication with an external apparatus. Specifically, the communication unit 17 is configured with a mobile phone-based mobile communication system which is called 3G or 4G communication, a module which performs wireless communication such as a local area network (LAN) by IEEE 802.11 series, or a module which performs wired communication such as a wired LAN or a USB. Accordingly, it is possible to transmit and receive various data items to and from an external apparatus such as the display apparatus 2, for example.

The memory unit 21 is configured with a semiconductor memory such as a dynamic random access memory (DRAM) and the captured image data acquired by the image processing unit 12 and various data items used by the control unit 18 are temporarily stored therein.

The operation unit 19 includes hardware keys such as a shutter button (release button), up, down, right and left arrow keys, a determination key, and a cancel key, and operation elements such as an operation dial, a touch panel, and a zoom lever, detects an input operation by a user, and transmits information (operation input information) corresponding to the input operation to the control unit 18. The control unit 18 determines the operation of the imaging apparatus 1 according to the operation input information and controls so that each unit performs necessary operations.

The sensor unit 20 includes a gyro sensor which detects angular velocity, an acceleration sensor which detects acceleration, a global positioning system (GPS) sensor which detects the current position, or a magnetic sensor which detects a size or a direction of a magnetic field, and performs detection of various information items.

The control unit 18 is, for example, configured with a microcomputer including a CPU, a read only memory (ROM), and a random access memory (RAM) and controls each unit of the imaging apparatus 1 by executing the processes based on a program stored in the ROM, for example.

Here, a panoramic imaging mode for performing the panoramic image is prepared in the imaging apparatus 1. A photographer may operate the predetermined operation element provided in the operation unit 19 and perform operation input for instructing the transition to the panoramic imaging mode. In a case of this example, in the panoramic imaging mode, a pressing operation of the shutter button is operated operations of the start or the finishing of the panoramic imaging. That is, in the panoramic imaging mode, when a photographer presses the shutter button once, a process of generating the panoramic frame image data items FM at predetermined time intervals, for example, as the panoramic imaging is started, and when a photographer presses the shutter button again, the process is finished. A photographer sweeps the imaging apparatus 1 between the first and second pressing operations of the shutter button. Accordingly, the n panoramic frame image data items FM shown in FIG. 3B are generated.

In order to realize the generation of the n panoramic frame image data items FM by such panoramic imaging, in the panoramic imaging mode, the control unit 18 monitors the pressing operation of the shutter button and causes the image signal processing unit 12 to execute the generation of the captured image data (still image) at predetermined time intervals according to the pressing operation of the shutter button. The captured image data items generated during the panoramic imaging mode are stored in the memory unit 21. The control unit 18 stops the generation process of the captured image data items at predetermined time intervals performed by the image signal processing unit 12, according to the second pressing operation of the shutter button, and causes the panoramic synthesis processing unit 13 to execute the panoramic synthesis process regarding the n captured image data items (panoramic frame image data items FM) stored in the memory unit 21 to generate the panoramic image data.

The finishing conditions of the panoramic imaging are not limited to the second pressing operation of the shutter button and may be various operations. For example, the releasing of the pressing operation of the shutter button may be the finishing conditions (that is, in this case, it is necessary to continuously press the shutter button for continuing the generation of the panoramic frame image data items FM). Alternatively, the finishing of the sweeping operation may be the finishing conditions. In a case where an angle of the panoramic imaging (rotation angle of the imaging apparatus 1 by the sweeping) is previously selected from angles of 180 degrees, 270 degrees, and 360 degrees, the rotation angle of the imaging apparatus 1 approached the selected rotation angle from the start condition satisfaction of the panoramic imaging (pressing operation of the shutter button) may be the finishing conditions. In this case, the rotation angle of the imaging apparatus 1 may be detected based on the detection information performed by the sensor unit 20.

The control unit 18 executes a process for realizing the functions of the distortion degree information subsidiary control unit 1a and the recording control unit 1b described above.

### 1-3. Subsidiary Control of Distortion Degree Information and Recording Control

Here, in the first embodiment, the distortion degree information Ds is subsidiarily applied with respect to the panoramic image data acquired by the sweeping panoramic imaging.

Specifically, in this example, the information of an angle of view θ of the panoramic image data as the distortion degree information Ds is acquired and is subsidiarily applied to the panoramic image data.

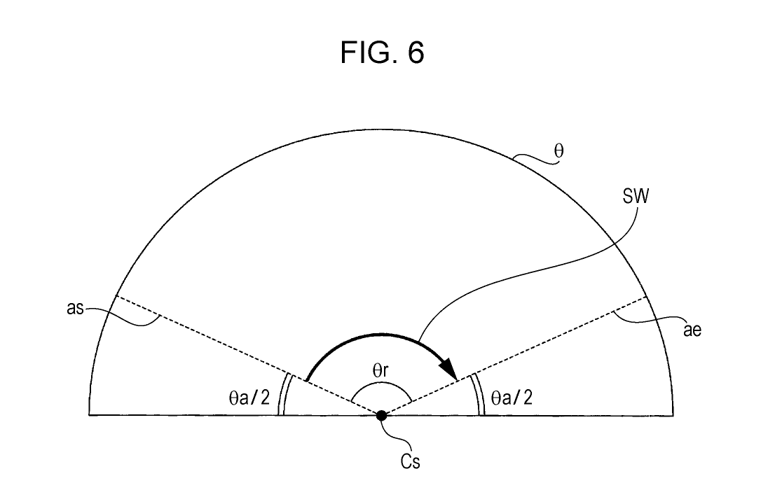

FIG. 6 is an explanatory diagram of the angle of view θ of the panoramic image data.

In FIG. 6, an arrow SW schematically indicates a track obtained by sweeping (rotating) the imaging apparatus 1 using the rotation shaft Cs as the center at the time of the panoramic imaging. A rotation angle θr means an angle of the imaging apparatus 1 rotated according to the sweeping described above.

“as” in the drawing schematically indicates an optical axis position of the imaging apparatus 1 at the time of the start of the panoramic imaging and “ae” schematically indicates an optical axis position of the imaging apparatus 1 at the time of the finishing of the panoramic imaging. The optical axis position as may be assumed as an optical axis position of the imaging apparatus 1 when the first panoramic frame image data FM#0 is imaged in the panoramic imaging, and the optical axis position ae may be assumed as an optical axis position of the imaging apparatus 1 when the final panoramic frame image data FM#(n−1) is imaged in the panoramic imaging.

The panoramic frame image data FM#0 and the panoramic frame image data FM#(n−1) may be expressed as “one end side captured image data” and “the other end side captured image data” having a maximum difference from each other in the imaging direction.

The rotation angle θr may be expressed as an “imaging direction maximum difference angle” which is an angle of a difference between the one end side captured image data and the other end side captured image data in the imaging direction.

Here, an angle in the panoramic imaging (angle of the panoramic frame image data FM) is set as an angle θa. The angle θa in this case means an angle acquired from the size of the imaging device 11 and the focal length of the lens unit 10, without considering the distortion of the lens.

Regarding the panoramic frame image data FM#0 as the one end side captured image data, a position of the image end in a direction opposite to the sweeping direction may be referred to as a direction deviated from the optical axis direction as in the same direction by θa/2 degrees. In addition, regarding the panoramic frame image data FM#(n−1) as the other end side captured image data, a position of the image end in a direction same as the sweeping direction may be referred to as a direction deviated from the optical axis direction as in the same direction by θa/2 degrees.

Accordingly, the angle θ of the panoramic image data may be acquired as a value obtained by adding θa/2 and θa/2 to the rotation angle θr, that is, as “θr+θa”.

In this case, the rotation angle θr may be acquired based on the detection information of the sensor unit 20.

Specifically, in this example, the rotation angle θr is acquired as a value obtained by adding an average angular velocity ω when performing the panoramic imaging (at the time of the sweeping) and panoramic imaging duration Tp as duration from the start and the end of the panoramic imaging.

The rotation angle θr may also be acquired from a movement amount of the imaging apparatus 1 in the sweeping which is acquired based on the detection information of the acceleration sensor. Alternatively, the rotation angle θr may also be acquired as a difference of angles, by detecting azimuths when starting and finishing the panoramic imaging based on the detection information of the magnetic sensor, and the specific detection method is not limited to the method using the average angular velocity ω and the panoramic imaging duration Tp.

The control unit 18 shown in FIG. 5 acquires the angle of view θ acquired by performing the calculation of “θr+θa” described above as the distortion degree information Ds.

The control unit 18 controls so that the acquired distortion degree information Ds is subsidiarily applied to the panoramic image data. In a case of this example, the subsidiary application of the distortion degree information Ds to the panoramic image data is performed by causing the encoding and decoding unit 14 to encode the panoramic image data and embed the data as metadata of the obtained image file. That is, the control unit 18 performs an instruction with respect to the encoding and decoding unit 14 so that the acquired distortion degree information Ds is embedded as metadata of the encoded image file of the panoramic image data described above.

The control unit 18 performs an instruction with respect to the recording and reproduction device 15 so that the captured image data including the subsidiarily applied distortion degree information Ds is recorded in a recording medium, as a process corresponding to the recording control unit 1b described above.

### 1-4. Process Procedure

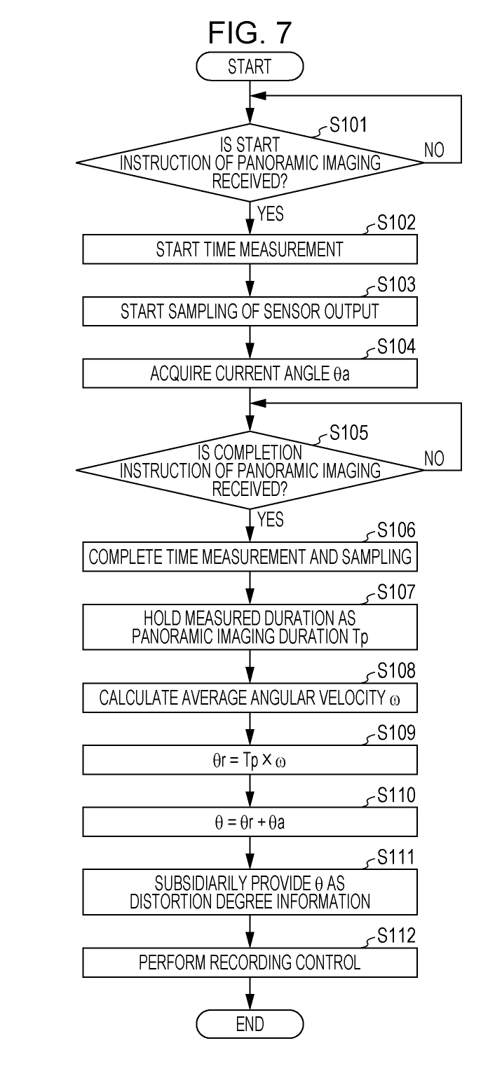

A specific process procedure to be performed for realize the functions of the distortion degree information subsidiary control unit 1a and the recording control unit 1b will be described with reference to a flowchart of FIG. 7.

The process shown in FIG. 7 is executed by the control unit 18 according to a program stored in the ROM described above.

In FIG. 7, the control unit 18 stands by until a start instruction of the panoramic imaging is performed in step S101. That is, in this example, the control unit stands by until the shutter button of the operation unit 19 is pressed in the panoramic imaging mode.

When the start instruction of the panoramic imaging is performed, the control unit 18 starts the time measurement in step S102 and starts sampling of sensor output in subsequent step S103. Specifically, the sampling of the information of the angular velocity detected by the gyro sensor of the sensor unit 20 is started.

Next, the control unit 18 acquires the information of the current angle θa in step S104.

The control unit 18 stands by until a finishing instruction of the panoramic imaging is performed in step S105, in response to the fact that the information of the angle θa is acquired. That is, in this example, the control unit stands by until the shutter button is pressed again.

When the finishing instruction of the panoramic imaging is performed, the control unit 18 finishes the time measurement (time measurement started in step S102) and the sampling (sampling started in step S103) in step S106.

The control unit 18 holds the measured duration as the panoramic imaging duration Tp in the subsequent step S107 and calculates the average angular velocity ω in step S108. That is, the average angle of the sampled angular velocity is calculated as the average angular velocity ω.

After acquiring the information of the panoramic imaging duration Tp and the average angular velocity ω as described above, the control unit 18 calculates the rotation angle θr by performing “panoramic imaging duration Tp×average angular velocity ω” in step S109 and calculates the angle of view θ of the panoramic image data by performing “rotation angle θr×angle of view θa” in step S110.

The control unit 18 performs a process of subsidiarily providing the angle of view θ as the distortion degree information Ds in step S111, in response to the fact that the angle of view θ is calculated. That is, the control unit performs an instruction with respect to the encoding and decoding unit 14 so that the distortion degree information Ds with the angle of view θ is embedded as metadata of the encoded image file of the panoramic image data.

In the subsequent step S112, the control unit 18 performs a recording control process regarding the panoramic image data including the subsidiarily applied distortion degree information Ds by the process in step S111. That is, the control unit performs an instruction with respect to the recording and reproduction device 15 so that the panoramic image data is recorded in a recording medium.

The control unit 18 completes a process shown in the drawing in response to the fact that the recording control process in step S112 is executed.

The functions as the distortion degree information subsidiary control unit 1a and the recording control unit 1b described above are realized by the process shown in FIG. 7.

### 1-5. Image Distortion Corresponding Processing Apparatus

### Configuration and Processing Example I

Next, the display apparatus 2 will be described.

For a configuration and a processing example of the display apparatus 2, configuration and processing examples I to III may be exemplified.

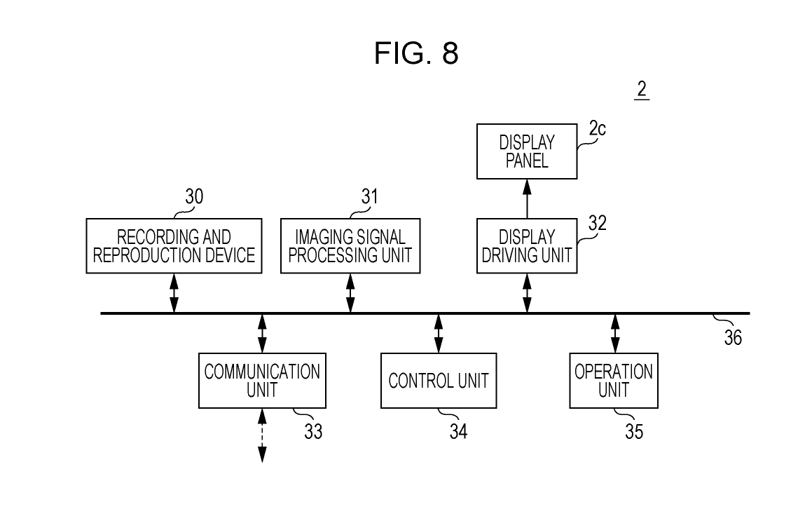

FIG. 8 is a block diagram showing an inner hardware configuration of the display apparatus 2 which corresponds to a configuration and processing example I.

The display apparatus 2 in this example includes the display panel 2c and further includes a recording and reproduction device 30, an image signal processing unit 31, a display driving unit 32, a communication unit 33, a control unit 34, an operation unit 35, and a bus 36. The recording and reproduction device 30, the image signal processing unit 31, the display driving unit 32, the communication unit 33, the control unit 34, the operation unit 35 are connected to each other through the bus 36 and transmit and receive the image data or a control signal to and from each other.

In the same manner as that of the recording and reproduction device 15 shown in FIG. 5, the recording and reproduction device 30 is configured with recording and reproduction circuit and mechanism with respect to a recording medium such as a memory card including a semiconductor memory such as a flash memory or a removable medium such as a magnetic disc, an optical disc, or a magnetooptical disc, and performs data recording with respect to a recording medium and reproduction of various data items such as image files recorded in a recording medium, based on an instruction from the control unit 34.

The recording and reproduction device 30 may perform the recording and reproduction with respect to a recording medium embedded in the display apparatus 2.

The image signal processing unit 31 performs a decoding process for an image file as a still image file or an image file as a moving image file based on an instruction from the control unit 34, and performs various image signal processes for the decoded image data. The image signal processing unit 31 at least may execute a distortion correction process of correcting the image distortion as an image signal process.

The display driving unit 32 includes a display driving circuit for driving pixels of the display panel 2c, and performs display driving of the display panel 2c so as to perform the display of the image based on the decoded image data by the image processing unit 31 and other information items, based on an instruction from the control unit 34.

The display panel 2c in this example is a display panel (curvature fixed panel) in which the curvature of the display surface is fixed. As the display panel 2c in this case, any one of a flat display panel having a flat display surface and a curved display panel having a curved display surface may be used.

The surface of the curved display panel is curved at least in a long side direction (transverse direction in this example) of the display surface having an approximately rectangular shape, and when seen from a position facing the display surface, the center of the display surface in the long side direction is positioned on the innermost side and end portions thereof in the long side direction are positioned on the outermost side.

The communication unit 33 performs wired or wireless communication or network communication with an external apparatus.

The operation unit 35 includes various operation elements, detects an input operation by a user, and transmits information (operation input information) corresponding to the input operation to the control unit 34. The control unit 34 determines the operation of the display apparatus 2 according to the operation input information and controls so that each unit performs necessary operations.

The operation input with respect to the display apparatus 2 may also be configured so as to be performed through a remote controller.

The control unit 34 is, for example, configured with a microcomputer including a CPU, a ROM, and a RAM and controls each unit of the display apparatus 2 by executing the processes based on a program stored in the ROM, for example.

Here, the display apparatus 2 having the configuration described above may acquire the panoramic image data to which the distortion degree information Ds is subsidiarily applied by the imaging apparatus 1, through a removable medium or the communication unit 33. As is understandable from the above point, the recording and reproduction device 30 or the communication unit 33 also have the function of the image acquisition unit 2a described above.

The control unit 34 of this example performs an instruction with respect to the image signal processing unit 31 so that the distortion correction process of the panoramic image data is performed, based on the distortion degree information Ds which is subsidiarily applied to the panoramic image data acquired by the recording and reproduction device 30 or the communication unit 33 having the function as the image acquisition unit 2a as described above.

For example, the control unit 34 instructs execution of the distortion correction process of the panoramic image data according to the operation input for instructing the display of the panoramic image data acquired by the recording and reproduction device 30 or the communication unit 33, and performs an instruction with respect to the display driving unit 32 so that the image display is performed on the display panel 2c based on the panoramic image data subjected to the distortion correction process.

In this case, in a case where the display panel 2c is the flat display panel, as the distortion correction process, the correction is performed so as to aim to set the degree of distortion of the acquired panoramic image data as zero.

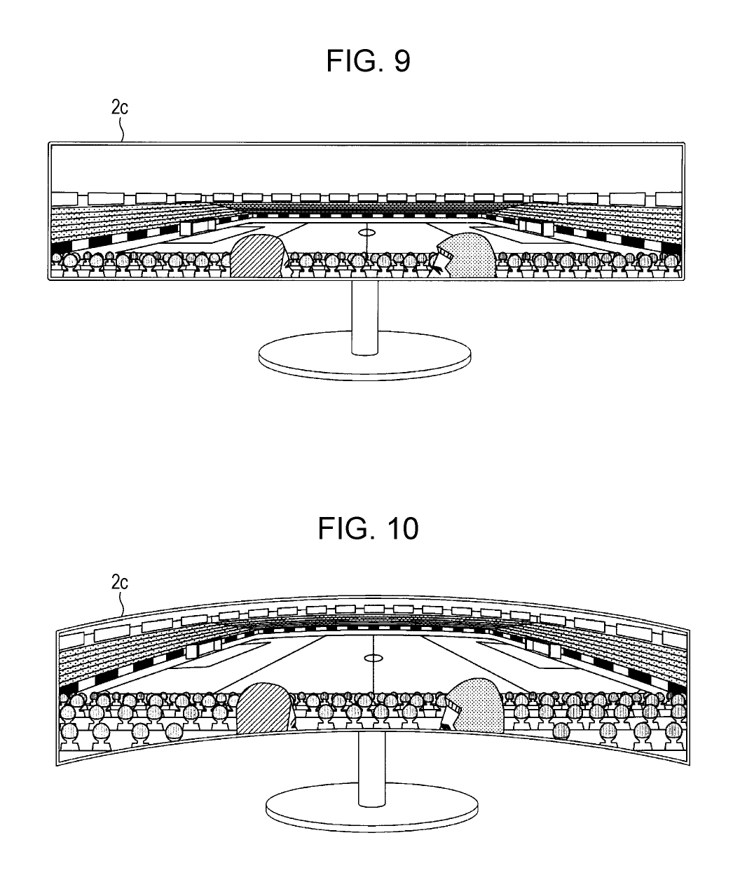

Since the image based on the panoramic image data subjected to the distortion correction process described above is displayed on the display panel 2c as the flat display panel, the image display which does not apply strangeness to an observer, is realized, as shown in FIG. 9.

Alternatively, in a case where the display panel 2c is the curved display panel, the distortion correction process is executed according to a difference between a degree of distortion shown by the acquired distortion degree information Ds and a degree of distortion corresponding to the curvature of the display panel 2c. Specifically, the distortion correction process for eliminating the difference between the degree of distortion shown by the distortion degree information Ds and the degree of distortion corresponding to the curvature of the display panel 2c is executed. That is, the distortion correction process is executed so as to aim to match the degree of distortion shown by the acquired panoramic image data and the degree of distortion corresponding to the curvature of the display panel 2c.

Here, the degree of distortion corresponding to the curvature of the display panel 2c means a degree of distortion of an image in which the image distortion is substantially not recognized by an observer when the image is displayed on the display panel 2c having the curvature.

In the display apparatus 2 of this case, the information of the degree of distortion corresponding to the curvature of the display panel 2c is stored in a storage apparatus which is readable by the control unit 34 such as the ROM or the like described above, for example. The control unit 34 reads out and acquires the information of the degree of distortion corresponding to the curvature of the display panel 2c stored as described above, instructs the image signal processing unit 31 to perform the distortion correction process by setting the acquired degree of distortion as a target degree of distortion.

FIG. 10 shows an image when the image subjected to the distortion correction process according to a difference between the degree of distortion of the information and the distortion degree corresponding to the curvature of the display panel 2c is displayed on the display panel 2c as the curved display panel.

As described above, since the image having the distortion corresponding to the curvature of the curved display panel is displayed on the curved display panel, it is possible to appropriately apply realistic feeling without applying strangeness to an observer.

### Configuration and Processing Example II

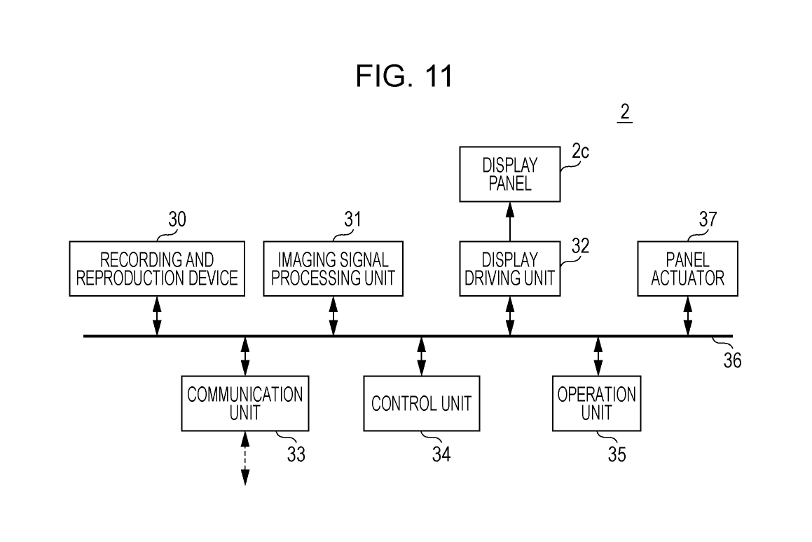

FIG. 11 is a block diagram showing an inner hardware configuration of the display apparatus 2 corresponding to a configuration and processing example II.

In the following description, the same reference numerals are applied to the same part as the part which is already described above and the description thereof will be omitted.

The configuration and processing example II corresponds to a case where the display panel 2c is a curvature variable display panel in which the curvature of the display surface is variable.

The display apparatus 2 of this case is provided with a panel actuator 37, in addition to the configuration shown in FIG. 8. The panel actuator 37 may transmit and receive various signals to and from the control unit 34 through the bus 36.

The display panel 2c of this case is configured so as to change the curvature of the display surface according to a driving force generated by the panel actuator 37.

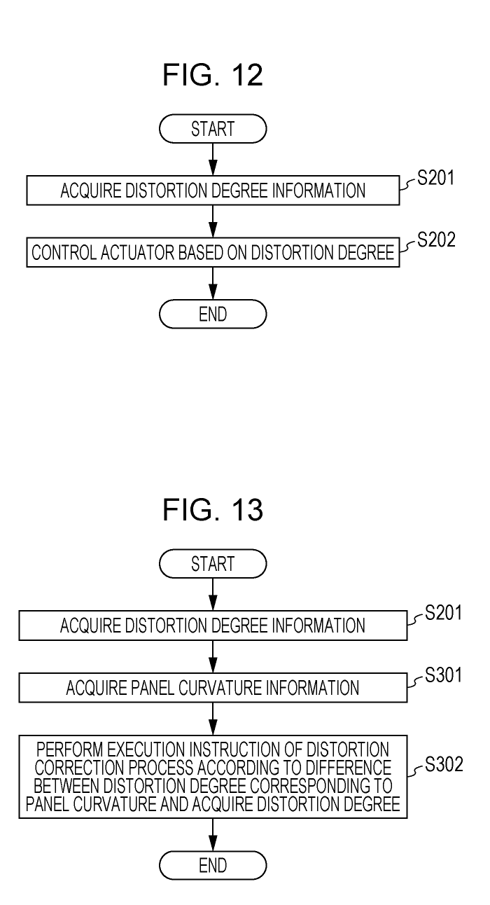

FIG. 12 is a flowchart showing a procedure of a process executed in the display apparatus 2 as the configuration and processing example II.

The process shown in FIG. 12 is executed by the control unit 34 base on a program stored in the ROM described above. The process shown in FIG. 12 is started according to the operation input for instructing the display of the panoramic image data acquired by the recording and reproduction device 30 or the communication unit 33, for example.

First, the control unit 34 executes a process of acquiring the distortion degree information Ds in step S201. That is, the distortion degree information Ds subsidiarily applied to the panoramic image data acquired by the recording and reproduction device 30 or the communication unit 33 is acquired.

The control unit 34 controls the panel actuator 37 based on the distortion degree information Ds in the subsequent step S202. Specifically, the control unit controls the panel actuator 37 so that the curvature of the display panel 2c becomes the curvature corresponding to the degree of distortion shown by the acquired distortion degree information Ds.

In a case of this example, the correspondence relationship information showing correspondence relationship between the degree of distortion and the curvature of the display panel 2c is stored in the display apparatus 2. The control unit 34 acquires the information of the curvature corresponding to the distortion degree information Ds based on the correspondence relationship information and controls the panel actuator 37 so that the curvature of the display panel 2c is matched with the acquired curvature.

Accordingly, the curvature of the display panel 2c is adjusted to the curvature corresponding to the degree of distortion of the image of the panoramic image data as the display target.

An image when the panoramic image data is displayed on the display panel 2c having the adjusted curvature as described above is the same as that previously shown in FIG. 10. As is understandable from the above point, in a case of performing the image display based on the captured image data in which the distortion of the image is generated, it is possible to appropriately apply realistic feeling without applying strangeness to an observer, by the curvature adjustment described above.

### Configuration and Processing Example III

In a configuration and processing example III, a distortion correction process according to a difference between the degree of distortion shown by the distortion degree information Ds and the degree of distortion corresponding to the curvature of the display panel 2c is performed, in a case where the display panel 2c as the curvature variable display panel is used.

Here, for the display apparatus 2 including the display panel 2c as the curvature variable display panel, a user may designate the curvature of the display panel 2c and appreciate the displayed image. For example, when a plurality of persons stand in front of the display panel 2c and appreciate the displayed image, it is difficult to set the curvature of the display panel 2c too large, in consideration of visibility of person positioning at an edges. For example, as is represented in this case, it is desirable not to change the curvature of the display panel 2c from the curvature designated by a user, in some cases.

In the configuration and processing example III, the distortion correction process is performed according to the difference between the degree of distortion shown by the distortion degree information Ds and the degree of distortion corresponding to the curvature of the display panel 2c, in response to the case where the curvature of the display panel 2c is designated by a user as described above.

The hardware configuration of the display apparatus 2 corresponding to the configuration and processing example III is the same as that described in FIG. 11, and the description with the drawing is omitted.

FIG. 13 is a flowchart showing a procedure of a process executed in the display apparatus 2 as the configuration and processing example III.

The process shown in FIG. 13 is executed by the control unit 34 base on a program stored in the ROM described above. In the same manner as in FIG. 12 described above, the process shown in FIG. 13 is also started according to the operation input for instructing the display of the panoramic image data acquired by the recording and reproduction device 30 or the communication unit 33, for example.

The same step number is applied to the same process as the process described above and the specific description thereof will be omitted.

The control unit 34 of this case acquires the distortion degree information Ds in step S201 and acquires the panel curvature information in the subsequent step S301. That is, the information of the current curvature of the display panel 2c is acquired. Since the control unit 34 controls the panel actuator 37 and performs the curvature adjustment of the display panel 2c by itself, the curvature information of the display panel 2c is grasped.

The control unit 34 performs an execution instruction of the distortion correction process according to the difference between the degree of distortion corresponding to the curvature of the display panel 2c and the degree of distortion shown by the acquired distortion degree information Ds in the subsequent step S302.

In the display apparatus 2 of this case, the correspondence relationship information showing correspondence relationship between the curvature of the display panel 2c and the degree of distortion is stored, and the control unit 34 acquires the information regarding the degree of distortion corresponding to the curvature of the display panel 2c based on the correspondence relationship information stored as described above. The control unit performs an instruction with respect to the image signal processing unit 31 so as to execute the distortion correction process according to the degree of distortion corresponding to the curvature of the display panel 2c and the degree of distortion shown by the acquired distortion degree information Ds. Specifically, the control unit performs an instruction to perform the distortion correction process so as to aim to match the degree of distortion of the acquired panoramic image data and the degree of distortion corresponding to the curvature of the display panel 2c.

According to the configuration and processing example III, since the image having the distortion corresponding to the current set curvature of the display panel 2c is displayed on the curvature variable display panel 2c, it is possible to appropriately apply realistic feeling without applying strangeness to an observer.

### 2. Second Embodiment

### 2-1. Outline of Image Display System

Next, a second embodiment will be described.

In the second embodiment, a plurality of captured image data items imaged by a plurality of imaging apparatuses which perform imaging in directions different from each other, are synthesized to generate panoramic image data.

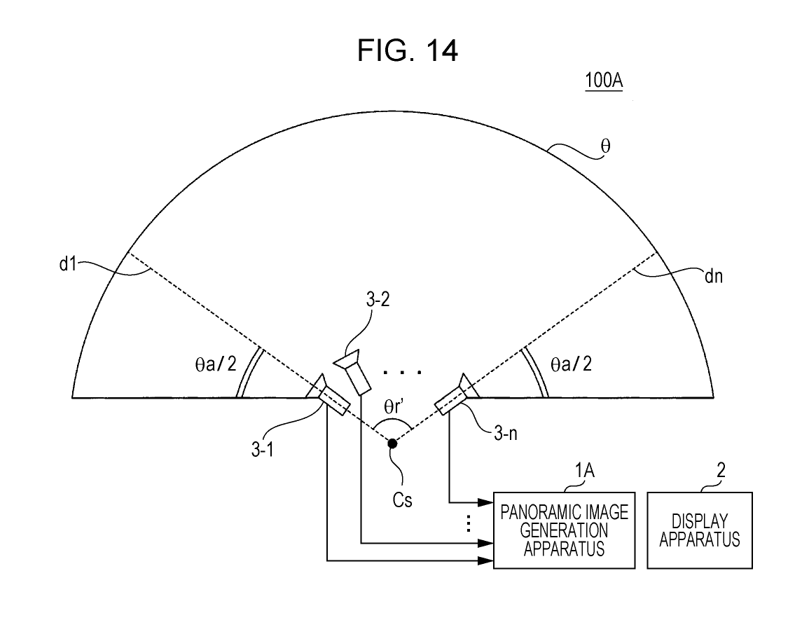

FIG. 14 is an explanatory diagram of an outline of an image display system 100A of the second embodiment.

As shown in the drawing, the image display system 100A includes a plurality of (n) imaging apparatuses 3, a panoramic image generation apparatus 1A, and the display apparatus 2.

The plurality of imaging apparatuses 3 are disposed so that those perform the imaging in directions different from each other. Specifically, The plurality of imaging apparatuses are disposed so that an imaging direction by each of the imaging apparatuses 3 is set as a radial direction using the spot Cs as the center.

Here, as shown in FIG. 14, regarding the plurality of imaging apparatuses 3, the numbers of imaging apparatuses 3 are applied in the order from the imaging apparatus 3 positioned at the most left end portion on the paper surface, and those are represented as the imaging apparatus 3-1, the imaging apparatus 3-2, . . . the imaging apparatus 3-n. The imaging apparatus 3-1 and the imaging apparatus 3-n may be expressed as one end side imaging apparatus and the other end side imaging apparatus having the maximum difference between angles in the imaging direction.

In a case of this example, the imaging apparatuses 3-1 to 3-n are fixed on a tripod set on a camera platform. The rotation angles of the imaging apparatuses 3-1 to 3-n in the panning direction are adjusted by the camera platform and the imaging direction of each imaging apparatus 3 is set to the direction described above.

The panoramic image generation apparatus 1A synthesizes the plurality of captured image data items imaged by the imaging apparatuses 3-1 to 3-n and generates the panoramic image data. In addition, the panoramic image generation apparatus 1A has a function as the distortion degree information subsidiary control unit 1a and the recording control unit 1b described above. That is, the panoramic image generation apparatus 1A is an embodiment of an image data processing apparatus according to the present technology.

The display apparatus 2 is the display apparatus 2 configured with any one of the configuration and processing examples I to III described in the first embodiment. A point different from the case of the first embodiment is a point that the panoramic image data to be acquired (and the distortion degree information Ds) is generated by the panoramic image generation apparatus 1A, and the functions as the image acquisition unit 2a and the image distortion corresponding processing unit 2b are the same as the case in the first embodiment.

### 2-2. Configuration of Image Data Processing Apparatus

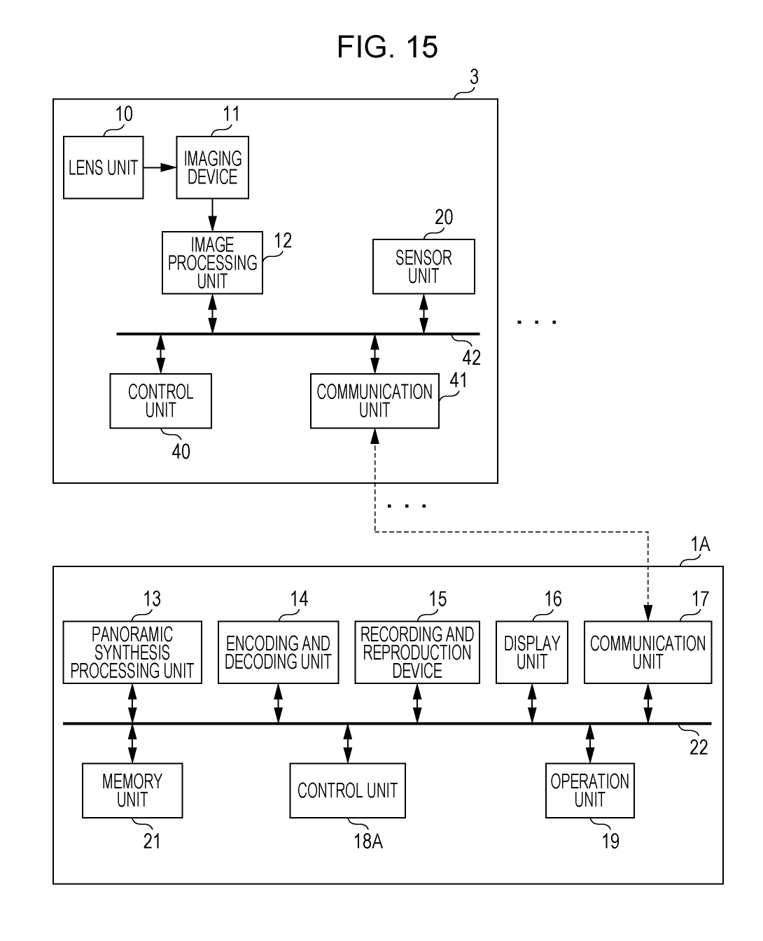

FIG. 15 is a block diagram showing respective inner hardware configurations of the imaging apparatus 3 and the panoramic image generation apparatus 1A.

The imaging apparatus 3 includes the lens unit 10, the imaging device 11, the image processing unit 12, and the sensor unit 20 which are the same elements included by the imaging apparatus 1 of the first embodiment and further includes a control unit 40, a communication unit 41, and a bus 42. The image processing unit 12, the sensor unit 20, the control unit 40, and the communication unit 41 connected to each other through the bus 42 and transmit and receive the image data or a control signal to and from each other.

The communication unit 41 performs wired or wireless communication or network communication with an external apparatus. Particularly, in a case of this example, the communication between the panoramic image generation apparatus 1A and the external apparatus.

The control unit 40 is, for example, configured with a microcomputer including a CPU, a ROM, and a RAM and controls each unit of the imaging apparatus 3 by executing the processes based on a program stored in the ROM, for example.

For example, the control unit 40 causes the image processing unit 12 to generate the captured image data based on the imaging signal from the imaging device 11, according to the fact that an imaging instruction signal from a control unit 18A which will be described later of the panoramic image generation apparatus 1A is input through the communication unit 41, and executes a process of transmitting the generated captured image data (corresponding to panoramic frame image data FM) to the panoramic image generation apparatus 1A through the communication unit 41. The control unit 40 performs a process of transmitting various information items such as the detection information obtained by the sensor unit 20 to the panoramic image generation apparatus 1A side through the communication unit 41, based on an instruction from the control unit 18A of the panoramic image generation apparatus 1A.

The panoramic image generation apparatus 1A includes the panoramic synthesis processing unit 13, the encoding and decoding unit 14, the recording and reproduction device 15, the display unit 16, the communication unit 17, the operation unit 19, the memory unit 21, and the bus 22 which are the same elements included by the imaging apparatus 1 of the first embodiment and further includes the control unit 18A.

The control unit 18A is connected to the bus 22 and the communication between the control unit 18A and the panoramic synthesis processing unit 13, the encoding and decoding unit 14, the recording and reproduction device 15, the display unit 16, the communication unit 17, the operation unit 19, and the memory unit 21 may be performed. The control unit 18A is, for example, configured with a microcomputer including a CPU, a ROM, and a RAM and controls each unit of the panoramic image generation apparatus 1A by executing the processes based on a program stored in the ROM, for example.

Particularly, the control unit 18A transmits the imaging instruction signal to each imaging apparatus 3 through the communication unit 17, based on the operation input from the operation unit 19 and causes each imaging apparatus 3 to generate the captured image data and to transmit the generated captured image data to the panoramic image generation apparatus 1A side. The control unit 18A causes the memory unit 21 to temporarily store the plurality of captured image data items transmitted from the each imaging apparatus 3 and received through the communication unit 17, causes the panoramic synthesis processing unit 13 to synthesize the plurality of captured image data items temporarily stored in the memory unit 21 as described above, and generates the panoramic image data.

### 2-3. Subsidiary Control of Distortion Degree Information and Recording Control

First, a method of acquiring the distortion degree information Ds of the second embodiment will be described.

In the embodiment as well, the distortion degree information Ds of the panoramic image data is information of the angle of view θ of the panoramic image data.

As shown in FIG. 14, the angle of view θ of the panoramic image data in a case of the second embodiment may be expressed as a value obtained by adding a half value of the angle of view θa of the imaging apparatus 3-1 “θa/2” and a half value of the angle of view θa of the imaging apparatus 3-n “θa/2” to an angle of a difference θr′ between the imaging apparatus 3-1 as the one end side imaging apparatus and the imaging apparatus 3-n as the other end side imaging apparatus (corresponding to “imaging direction maximum difference angle” described above). That is, the angle may be expressed as “θr′+θa”.

In the second embodiment, the angles of view θa of imaging apparatuses 3 when acquiring one panoramic image data item is set to be substantially the same with each other.

In the second embodiment, the angle of a difference θr′ is acquired based on the detection information obtained by the magnetic sensor provided in the sensor unit 20 of the imaging apparatus 3-1 and the imaging apparatus 3-n, for example. Specifically, in this example, an azimuth d1 of the optical axis of the imaging apparatus 3-1 and an azimuth dn of the optical axis of the imaging apparatus 3-n are acquired based on the detection information obtained by the magnetic sensor and a difference between the azimuth d1 and the azimuth dn is calculated as the angle of a difference θr′.

The angle of a difference θr′ may be acquired based on the detection information of a tilt sensor which detects a tilt angle of the imaging apparatus 3 in a circumferential direction having the spot Cs as the center, for example. Alternatively, when using the camera platform as in this example, it is possible to acquire the angle of a difference θr′ based on rotation angle information in the panning direction of the camera platform, and a method of acquiring the angle of a difference θr′ is not limited to a method based on the determination information of the magnetic sensor.

The control unit 18A of the panoramic image generation apparatus 1A controls so that the information of the angle of view θ calculated by “θr′+θa” is subsidiarily provided as the distortion degree information Ds of the panoramic frame image data. In this example as well, the distortion degree information Ds is subsidiarily provided as metadata of the image file obtained by encoding the panoramic image data by the encoding and decoding unit 14.

The control unit 18A performs an instruction with respect to the recording and reproduction device 15 so that the panoramic image data including the subsidiarily applied distortion degree information Ds is recorded in a recording medium.

### 2-4. Process Procedure

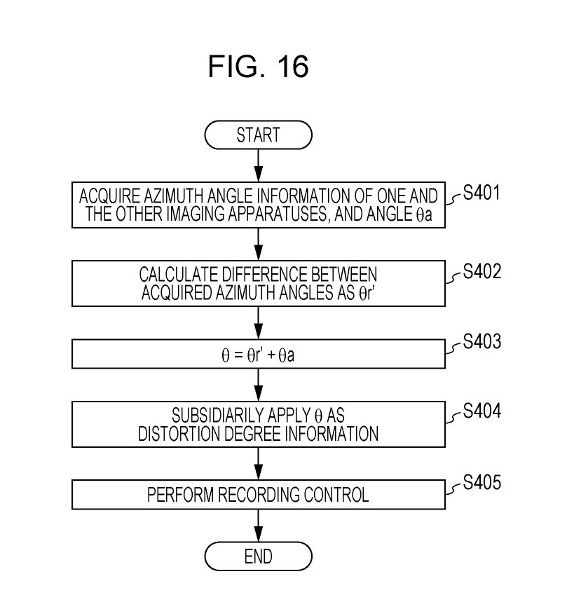

FIG. 16 is a flowchart showing a specific process procedure for realizing subsidiary control of the distortion degree information Ds and the recording control as the second embodiment described above.

The process shown in FIG. 16 is executed by the control unit 18A according to a program stored in the ROM described above.

The process shown in FIG. 16 is started according to the fact that the operation input of instructing the generation of the panoramic image data is performed from the operation unit 19. The process for realizing the transmission of the imaging instruction signal to each imaging apparatus 3 described above and the generation of the panoramic image data based on the captured image data transmitted from each imaging apparatus 3 according to the imaging instruction signal is performed in parallel with the process shown in FIG. 16.

In FIG. 16, the control unit 18A executes a process of acquiring azimuth angle information and angle of view θa of the imaging apparatuses 3 on one end side and the other end side (that is, imaging apparatus 3-1 and imaging apparatus 3-n) in step S401.

Specifically, the control unit 18A instructs the transmission of the detection information of the magnetic sensor and the information of the angle of view θa to the control unit 40 of the imaging apparatus 3-1 and the imaging apparatus 3-n, according to the operation input for instructing the generation of the panoramic image data described above. The detection information of the magnetic sensor and the information of the angle of view θa transmitted from the imaging apparatus 3-1 and the imaging apparatus 3-n are acquired according to the instruction, and the azimuth d1 of the imaging apparatus 3-1 and the azimuth dn of the imaging apparatus 3-n are acquired based on the acquired detection information of the magnetic sensor.

As described above, the control unit 18A calculates a difference between the acquired azimuth d1 and azimuth dn as the angle of the difference θr′ in step S402, in response to the fact that the information of the azimuth d1 and azimuth dn and the angle of view θa in step S401, and calculates the angle of view θ of the panoramic image data by “θr′+θa” in the subsequent step S403.

The control unit 18A performs a process of subsidiarily applying the calculated angle of view θ to the panoramic image data as the distortion degree information Ds in the subsequent step S403. That is, the control unit performs an instruction with respect to the encoding and decoding unit 14 so that the distortion degree information Ds with the angle of view θ is embedded as metadata of the encoded image file of the panoramic image data.

The control unit 18A performs a recording control process for the panoramic image data including subsidiarily applied distortion degree information Ds in the subsequent step S405. That is, the control unit performs an instruction with respect to the recording and reproduction device 15 so that the panoramic image data is recorded in a recording medium.

The control unit 18A completes the processes shown in this drawing according to the face the recording control process in step S405 is executed.

As described above, it is possible to cause the display apparatus 2 to acquire the panoramic image data through the recording medium or the communication unit 17 by recording the panoramic image data including the subsidiarily applied distortion degree information Ds in the recording medium, and any of the image distortion corresponding processes described as the configuration and processing example I to III are performed based on the panoramic image data including the subsidiarily applied distortion degree information Ds in the display apparatus 2.

Accordingly, it is possible to perform the appropriate image display corresponding to the display surface shape of the display panel 2c.

### 3. Third Embodiment

### 3-1. Configuration of Image Data Processing Apparatus

In a third embodiment, the captured image data in which the distortion of the image is generated is image data imaged by a wide-angle lens.

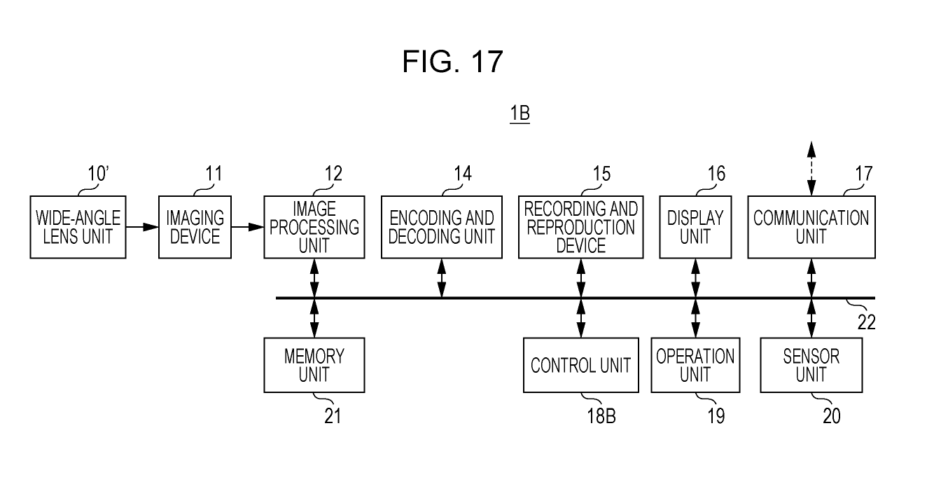

FIG. 17 is a block diagram showing an inner hardware configuration of an imaging apparatus 1B of the third embodiment.

The imaging apparatus 1B is provided with a wide-angle lens unit 10′ instead of the lens unit 10, compared to the imaging apparatus 1 of the first embodiment, the panoramic synthesis processing unit 13 is omitted, and a point that a control unit 18B is provided instead of the control unit 18 is a point different from that of the first embodiment.

The wide-angle lens unit 10′ is set as a lens unit belonging to a super-wide-angle lens for realizing the angle of view θa of 100 degrees or more, for example, in balance with the size of the imaging device 11. The distortion of the image is generated in the captured image data obtained by the imaging through the wide-angle lens unit 10′ described above.

The control unit 18B, for example, configured with a microcomputer including a CPU, a ROM, and a RAM and controls each unit of the imaging apparatus 1B by executing the processes based on a program stored in the ROM, for example.

### 3-2. Process Procedure

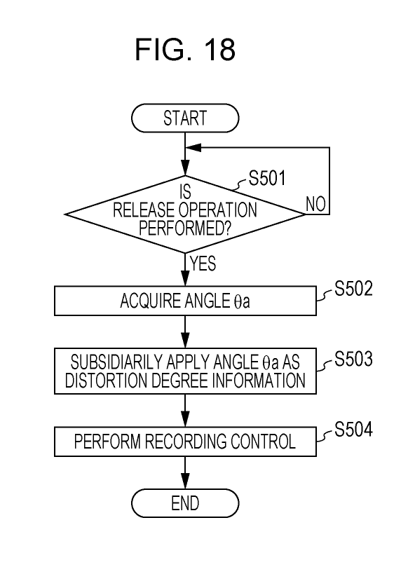

FIG. 18 is a flowchart showing a procedure of a process executed in the imaging apparatus 1B of the third embodiment.

The process shown in FIG. 18 is executed by the control unit 18B according to a program stored in the ROM described above.

In FIG. 18, the control unit 18B stands by until a release operation is performed in step S501. Specifically, the control unit stands by until the shutter button provided in the operation unit 19 is pressed.

When the release operation is performed, the control unit 18B acquires the information of the angle of view θa of the wide-angle lens unit 10′ in step S502. Specifically, the control unit acquires the information of the angle of view θa which is calculated based on the focal length of the wide-angle lens unit 10′ and the size of the imaging device 11.

In the subsequent step S503, the control unit 18B performs a process of subsidiarily applying the acquired information of the angle of view θa to the captured image data as the distortion degree information Ds, that is, the captured image data generated according to the release operation in step S501. Specifically, the control unit performs an instruction with respect to the encoding and decoding unit 14 so that the distortion degree information Ds with the angle of view θa is embedded as metadata of the encoded image file of the captured image data.

In addition, the control unit 18B performs a recording control process regarding the captured image data including the subsidiarily applied distortion degree information Ds in subsequent step S504. That is, the control unit performs an instruction with respect to the recording and reproduction device 15 so that the captured image data is recorded in a recording medium.

The control unit 18B completes a process shown in the drawing in response to the fact that the recording control process in step S504 is executed.

As described above, it is possible to cause the display apparatus 2 to acquire the captured image data through the recording medium or the communication unit 17 by recording the captured image data including the subsidiarily applied distortion degree information Ds (wide-angle captured image data) in the recording medium, and any of the image distortion corresponding processes described as the configuration and processing example I to III are performed based on the captured image data including the subsidiarily applied distortion degree information Ds in the display apparatus 2.

Accordingly, it is possible to perform the appropriate image display corresponding to the display surface shape of the display panel 2c.

The wide-angle lens unit 10′ may be a so-called interchangeable lens. In this case, particularly when the wide-angle lens unit 10′ as an interchangeable lens is a fixed focal lens, the control unit 18B may acquire the information of the angle of view θa of the wide-angle lens unit 10′ by performing the calculation based on the information of the focal length included in product information of the wide-angle lens unit 10′ stored in the wide-angle lens unit 10′ and the information of the size of the imaging device 11.

As described above, a case of performing the subsidiary control of the distortion degree information Ds and the recording control regarding the captured image data as a still image has been exemplified, but it is also possible to perform the subsidiary control of the distortion degree information Ds and the recording control regarding the captured image data as a moving image. In this case, in step S501, the control unit may stand by the operation input of instructing the recording start of the captured image data as a moving image such as a pressing operation of a REC button provided in the operation unit 19.

### 4. Conclusion of Embodiments

The image data processing apparatuses of the embodiments (the imaging apparatus 1, the panoramic image generation apparatus 1A, and the imaging apparatus 1B) include the distortion degree information subsidiary control unit 1a which subsidiarily applies the distortion degree information Ds correlating to the degree of the distortion of the image of the captured image data to the captured image data generated based on the captured image signal obtained by the imaging device 11, and the recording control unit 1b controls so that the captured image data including the subsidiarily applied distortion degree information Ds is recorded in a recording medium.

Accordingly, the distortion degree information Ds is subsidiarily applied to the captured image data in which the distortion of the image is generated, such as the panoramic image data or the wide-angle captured image data, for example, and is stored in a desired recording medium.

The display apparatus 2 may perform a corresponding process (image distortion corresponding process) for appropriately displaying the captured image data based on the distortion degree information Ds subsidiarily applied as described above.

Accordingly, according to the image data processing apparatuses of the embodiments, it is possible to perform appropriate image display according to the display surface shape of the display panel 2c, in a case of performing the image display based on the captured image data in which the distortion of the image is generated.

The image data processing apparatus of the first or second embodiment (the imaging apparatus 1 or the panoramic image generation apparatus 1A) includes the panoramic synthesis processing unit 13 which perform the panoramic synthesis of the plurality of captured image data items obtained by performing the imaging in directions different from each other and generates the panoramic image data, and the distortion degree information subsidiary control unit 1a generates the distortion degree information Ds based on the imaging direction maximum difference angle (θr and θr′) which is the angle of a difference between the one end side captured image data and the other end side captured image data having the maximum difference in the imaging direction among the plurality of the captured image data items, and subsidiarily applies the generated distortion degree information Ds to the captured image data as the panoramic image data.

Accordingly, the distortion degree information Ds appropriately correlating to the degree of the distortion of the image of the panoramic image data is subsidiarily applied to the panoramic image data.

Accordingly, it is possible to perform the appropriate image display corresponding to the display surface shape of the display panel 2c.

In the image data processing apparatus of the first or second embodiment, the distortion degree information subsidiary control unit 1a generates the distortion degree information Ds based on the imaging direction maximum difference angle and the angle of view θa of the one end side captured image data and the other end side captured image data.

Accordingly, the distortion degree information Ds more appropriately correlating to the degree of the distortion of the image of the panoramic image data is subsidiarily applied to the panoramic image data.

Accordingly, it is possible to perform the appropriate image display corresponding to the display surface shape of the display panel 2c.

In the image data processing apparatus of the first embodiment, the panoramic synthesis processing unit 13 synthesizes the plurality of captured image data items acquired by the sweeping panoramic imaging and generates the panoramic image data.

Accordingly, it is not necessary to use the plurality of imaging apparatuses for generating the panoramic image data.

Therefore, it is possible to more easily generate the panoramic image data.

In the image data processing apparatus of the first embodiment, the distortion degree information subsidiary control unit 1a calculates the imaging direction maximum difference angle based on the panoramic imaging duration Tp which is duration from the start to the end of the swing panoramic imaging and the average angular velocity ω of the swing operation of the swing panoramic imaging.

Accordingly, the imaging direction maximum difference angle in a case of generating the panoramic image data by the swing panoramic imaging is appropriately acquired.

Therefore, it is possible to subsidiarily apply the appropriate distortion degree information Ds to the panoramic image data and it is possible to perform the appropriate image display corresponding to the display surface shape of the display panel 2c.

In the image data processing apparatus of the second embodiment, the panoramic synthesis processing unit 13 synthesizes the plurality of captured image data items imaged by the imaging apparatuses 3-1 to 3-n which perform the imaging in directions different from each other and generates the panoramic image data.

Accordingly, it is possible to obtain the plurality of captured image data items necessary for the generation of the panoramic image data at the same time.

Therefore, it is possible to shorten the time necessary for the generation of the panoramic image data.

Since it is possible to image the plurality of captured image data items necessary for the generation of the panoramic image data at the same time, it is not necessary to determine the seams SM by avoiding a moving subject, as in a case of the swing panoramic imaging, and it is possible to easily perform the panoramic synthesis process. In this point as well, it is possible to shorten the time necessary for the generation of the panoramic image data.

Although not particularly stated in the above description, the image data processing apparatus of the second embodiment (panoramic image generation apparatus 1A) may generate moving image data based on the plurality of panoramic image data items generated by the panoramic synthesis processing unit 13 and perform the subsidiary control of the distortion degree information Ds and the recording control regarding the moving image data.

In the image data processing apparatus of the second embodiment, distortion degree information subsidiary control unit 1a calculates the imaging direction maximum difference angle based on the detection information of the magnetic sensor provided in the one end side imaging apparatus (imaging apparatus 3-1) and the other end side imaging apparatus (imaging apparatus 3-n) having the maximum difference between angles of the plurality of the imaging apparatuses 3-1 to 3-n in the imaging direction.

Accordingly, the imaging direction maximum difference angle in a case of acquiring the panoramic image data by synthesizing the captured image data by the plurality of the imaging apparatuses is appropriately acquired.

Therefore, it is possible to subsidiarily apply the appropriate distortion degree information Ds to the panoramic image data and it is possible to perform the appropriate image display corresponding to the display surface shape of the display panel 2c.

In the image data processing apparatus of the third embodiment, the distortion degree information subsidiary control unit 1a subsidiarily applies information of the angle θa calculated based on the focal length of the lens unit (wide-angle lens unit 10′) used in imaging for acquiring the captured image data and the size of the imaging device 11, to the captured image data as the distortion degree information Ds.

Accordingly, the distortion degree information Ds appropriately correlating to the degree of the distortion of the image of the captured image data is subsidiarily applied to the captured image data, in response to a case where the captured image data in which the distortion of the image is generated, is the captured image data acquired by the imaging through the wide-angle lens unit 10′.

Therefore, it is possible to perform the appropriate image display corresponding to the display surface shape of the display panel 2c.

The image distortion corresponding processing apparatus of the embodiment (display apparatus 2) includes the image acquisition unit 2a which acquires the captured image data generated based on the captured image signal acquired by the imaging device 11, that is, the captured image data to which the distortion degree information Ds correlating to the degree of the distortion of the image of the captured image data is subsidiarily applied, and the image distortion corresponding processing unit 2b which performs the control so that any one of the distortion correction process of the captured image data and the curvature adjustment of the curvature variable display panel in which a curvature of a display surface is variable, based on the distortion degree information Ds.

As described above, by performing any one of the distortion correction process and the curvature adjustment of the curvature variable display panel based on the distortion degree information Ds, it is possible to appropriately apply realistic feeling without applying strangeness to an observer, in response to a case of displaying the image based on the captured image data in which the distortion of the image is generated, on a curvature fixed display panel in which a curvature of a display surface is fixed or the curvature variable display panel.

Accordingly, it is possible to perform appropriate image display according to the display surface shape of the display panel 2c, in a case of performing the image display based on the captured image data in which the distortion of the image is generated.

The image distortion corresponding processing apparatus of the embodiment, the image distortion corresponding processing unit 2b includes a first display control unit (control unit 34 of the configuration and processing example I) which performs the control so as to execute the distortion correction process of the captured image data based on the distortion degree information Ds, and performs the control so as to display the image based on the captured image data subjected to the distortion correction process on the display panel 2c in which the curvature of the display surface is fixed.

Accordingly, it is possible to appropriately apply realistic feeling without applying strangeness to an observer, in response to a case of displaying the image based on the captured image data in which the distortion of the image is generated, on a curvature fixed display panel in which a curvature of a display surface is fixed.

Therefore, it is possible to perform appropriate image display according to the display surface shape of the display panel 2c, in a case of performing the image display based on the captured image data in which the distortion of the image is generated.

In the image distortion corresponding processing apparatus of the embodiment, the image distortion corresponding processing unit 2b includes a second display control unit (control unit 34 of the configuration and processing example II) which performs the control so as to perform the curvature adjustment of the curvature variable display panel based on the distortion degree information Ds, and performs the control so as to display the image based on the captured image data on the curvature variable display panel.

Accordingly, it is possible to appropriately apply realistic feeling without applying strangeness to an observer, in response to a case of displaying the image based on the captured image data in which the distortion of the image is generated, on the curvature variable display panel.

Therefore, it is possible to perform appropriate image display according to the display surface shape of the display panel 2c, in a case of performing the image display based on the captured image data in which the distortion of the image is generated.

In the image distortion corresponding processing apparatus of the embodiment, the image distortion corresponding processing unit 2b includes a third display control unit (control unit 34 of the configuration and processing example III) which performs the control so as to perform the distortion correction process according to the difference between the degree of distortion shown by the distortion degree information Ds and the degree of distortion corresponding to the curvature of the curvature variable display panel, and performs the control so as to display the image based on the captured image data subjected to the distortion correction process on the curvature variable display panel.

Accordingly, the image having the distortion corresponding to the current set curvature of the display panel 2c is displayed on the curvature variable display panel 2c, and thus, it is possible to appropriately apply realistic feeling without applying strangeness to an observer.

Therefore, it is possible to perform appropriate image display according to the current set curvature of the display panel 2c, even under the restriction such as the curvature of the display surface which is difficult to be largely set.

### 5. Modification Example

Hereinabove, the embodiments according to the present technology have been described, but the present technology is not limited to the exemplified specific examples.

For example, in the above description, the case where the distortion degree information Ds is set as the information of the angle of view θ or the angle of view θa calculated based on the focal length of the lens unit and the size of the imaging device 11 have been exemplified, but the distortion degree information Ds may be other information as long as it is information correlating to the degree of the distortion of the image, such as information obtained by measuring the degree of distortion of the image by the imaging process, for example.

In the above description, the case where each process in the distortion degree information subsidiary control unit 1a, the recording control unit 1b, the image acquisition unit 2a, and the image distortion corresponding processing unit 2b is executed with the software process by the CPU, but at least a part of the processes may be executed by the hardware.

The results described in this specification are merely examples, and there is no limitation. The other results may be acquired.

### 6. Present Technology

The present technology may also use the following configurations.

(1) An image data processing apparatus including:

a distortion degree information subsidiary control unit which subsidiarily applies distortion degree information correlating to a degree of distortion of an image of captured image data to the captured image data generated based on a captured image signal acquired by an imaging device; and

a recording control unit which performs control so that the captured image data including the subsidiarily applied distortion degree information is recorded in a recording medium.

(2) The image data processing apparatus according (1), further including:

a panoramic synthesis processing unit which performs panoramic synthesis of the plurality of captured image data items acquired by performing imaging in directions different from each other and generates panoramic image data,

in which the distortion degree information subsidiary control unit generates the distortion degree information based on an imaging direction maximum difference angle which is an angle of a difference between one end side captured image data and the other end side captured image data in an imaging direction having the maximum difference between angles in the moving direction among the plurality of captured image data items, and subsidiarily applies the generated distortion degree information to the captured image data as the panoramic image data.

(3) The image data processing apparatus according to (2),

in which the distortion degree information subsidiary control unit generates the distortion degree information based on the imaging direction maximum difference angle and angles of the one end side captured image data and the other end side captured image data.

(4) The image data processing apparatus according to (2) or (3),

in which the panoramic synthesis processing unit synthesizes the plurality of captured image data items acquired by swing panoramic imaging and generates the panoramic image data.

(5) The image data processing apparatus according to (4),

in which the distortion degree information subsidiary control unit calculates the imaging direction maximum difference angle based on panoramic imaging duration which is duration from the start to the end of the swing panoramic imaging and an average angular velocity of a swing operation of the swing panoramic imaging.

(6) The image data processing apparatus according to (2) or (3),

in which the panoramic synthesis processing unit synthesizes the plurality of captured image data items imaged by a plurality of imaging apparatuses which perform the imaging in directions different from each other and generates the panoramic image data.
(7) The image data processing apparatus according to (6),

in which the distortion degree information subsidiary control unit calculates the imaging direction maximum difference angle based on detection information of a magnetic sensor provided in the one end side imaging apparatus and the other end side imaging apparatus having the maximum difference between angles in the imaging direction among the plurality of imaging apparatuses.

(8) The image data processing apparatus according to (1),

in which the distortion degree information subsidiary control unit subsidiarily applies information of an angle of view calculated based on a focal length of a lens unit used in the imaging for acquiring the captured image data and a size of the imaging device, to the captured image data as the distortion degree information.

(9) An image data processing method including:

subsidiarily applying distortion degree information correlating to a degree of distortion of an image of captured image data to the captured image data generated based on a captured image signal acquired by an imaging device; and

performing control so that the captured image data including the subsidiarily applied distortion degree information is recorded in a recording medium.

(10) An image distortion corresponding processing apparatus including:

an image acquisition unit which acquires captured image data generated based on a captured image signal acquired by an imaging device, that is, the captured image data to which distortion degree information correlating to a degree of distortion of an image of the captured image data is subsidiarily applied; and

an image distortion corresponding processing unit which performs control so that any one of a distortion correction process of the captured image data and curvature adjustment of a curvature variable display panel in which a curvature of a display surface is variable, based on the distortion degree information.

(11) The image distortion corresponding processing apparatus according to (10),

in which the image distortion corresponding processing unit includes a first display control unit which performs control so as to execute a distortion correction process of the captured image data based on the distortion degree information, and performs control so as to display an image based on the captured image data subjected to the distortion correction process on a display panel in which a curvature of a display surface is fixed.

(12) The image distortion corresponding processing apparatus according to (10),

in which the image distortion corresponding processing unit includes a second display control unit which performs control so as to perform curvature adjustment of the curvature variable display panel based on the distortion degree information, and performs control so as to display an image based on the captured image data on the curvature variable display panel.

(13) The image distortion corresponding processing apparatus according to (10),

in which the image distortion corresponding processing unit includes a third display control unit which performs control so as to perform the distortion correction process according to a difference between a degree of distortion shown by the distortion degree information and a degree of distortion corresponding to a curvature of the curvature variable display panel, and performs control so as to display an image based on the captured image data subjected to the distortion correction process on the curvature variable display panel.

(14) An image distortion corresponding processing method including:

acquiring captured image data generated based on a captured image signal acquired by an imaging device, that is, the captured image data to which distortion degree information correlating to a degree of distortion of an image of the captured image data is subsidiarily applied; and

performing control so that any one of a distortion correction process of the captured image data and curvature adjustment of a curvature variable display panel in which a curvature of a display surface is variable, based on the distortion degree information.

It should be understood by those skilled in the art that various modifications, combinations, sub-combinations and alterations may occur depending on design requirements and other factors insofar as they are within the scope of the appended claims or the equivalents thereof.

What is claimed is:

1. An image data processing apparatus comprising:
a distortion degree information subsidiary control unit which subsidiarily applies distortion degree information correlating to a degree of distortion of an image of captured image data to the captured image data generated based on a captured image signal acquired by an imaging device; and
a recording control unit which performs control so that the captured image data including the subsidiarily applied distortion degree information is recorded in a recording medium.

2. The image data processing apparatus according to claim 1, further comprising:
a panoramic synthesis processing unit which performs panoramic synthesis of the plurality of captured image data items acquired by performing imaging in directions different from each other and generates panoramic image data,
wherein the distortion degree information subsidiary control unit generates the distortion degree information based on an imaging direction maximum difference angle which is an angle of a difference between one end side captured image data and the other end side captured image data in an imaging direction having the maximum difference between angles in the moving direction among the plurality of captured image data items, and subsidiarily applies the generated distortion degree information to the captured image data as the panoramic image data.

3. The image data processing apparatus according to claim 2,
wherein the distortion degree information subsidiary control unit generates the distortion degree information based on the imaging direction maximum difference angle and angles of the one end side captured image data and the other end side captured image data.

4. The image data processing apparatus according to claim 2,
wherein the panoramic synthesis processing unit synthesizes the plurality of captured image data items acquired by swing panoramic imaging and generates the panoramic image data.

5. The image data processing apparatus according to claim 4,
wherein the distortion degree information subsidiary control unit calculates the imaging direction maximum difference angle based on panoramic imaging duration which is duration from the start to the end of the swing panoramic imaging and an average angular velocity of a swing operation of the swing panoramic imaging.

6. The image data processing apparatus according to claim 2,
wherein the panoramic synthesis processing unit synthesizes the plurality of captured image data items imaged by a plurality of imaging apparatuses which perform the imaging in directions different from each other and generates the panoramic image data.

7. The image data processing apparatus according to claim 6,
wherein the distortion degree information subsidiary control unit calculates the imaging direction maximum difference angle based on detection information of a magnetic sensor provided in the one end side imaging apparatus and the other end side imaging apparatus having the maximum difference between angles in the imaging direction among the plurality of imaging apparatuses.

8. The image data processing apparatus according to claim 1,
wherein the distortion degree information subsidiary control unit subsidiarily applies information of an angle of view calculated based on a focal length of a lens unit used in the imaging for acquiring the captured image data and a size of the imaging device, to the captured image data as the distortion degree information.

9. An image data processing method comprising:
subsidiarily applying distortion degree information correlating to a degree of distortion of an image of captured image data to the captured image data generated based on a captured image signal acquired by an imaging device; and
performing control so that the captured image data including the subsidiarily applied distortion degree information is recorded in a recording medium.

10. An image distortion corresponding processing apparatus comprising:
an image acquisition unit which acquires captured image data generated based on a captured image signal acquired by an imaging device, that is, the captured image data to which distortion degree information correlating to a degree of distortion of an image of the captured image data is subsidiarily applied; and
an image distortion corresponding processing unit which performs control so that any one of a distortion correction process of the captured image data and curvature adjustment of a curvature variable display panel in which a curvature of a display surface is variable, based on the distortion degree information.

11. The image distortion corresponding processing apparatus according to claim 10,
wherein the image distortion corresponding processing unit includes a first display control unit which performs control so as to execute a distortion correction process of the captured image data based on the distortion degree information, and performs control so as to display an image based on the captured image data subjected to the distortion correction process on a display panel in which a curvature of a display surface is fixed.

12. The image distortion corresponding processing apparatus according to claim 10,
wherein the image distortion corresponding processing unit includes a second display control unit which performs control so as to perform curvature adjustment of the curvature variable display panel based on the distortion degree information, and performs control so as to display an image based on the captured image data on the curvature variable display panel.

13. The image distortion corresponding processing apparatus according to claim 10,
wherein the image distortion corresponding processing unit includes a third display control unit which performs control so as to perform the distortion correction process according to a difference between a degree of distortion shown by the distortion degree information and a degree of distortion corresponding to a curvature of the curvature variable display panel, and performs control so as to display an image based on the captured image data subjected to the distortion correction process on the curvature variable display panel.

14. An image distortion corresponding processing method comprising:
acquiring captured image data generated based on a captured image signal acquired by an imaging device, that is, the captured image data to which distortion degree information correlating to a degree of distortion of an image of the captured image data is subsidiarily applied; and
performing control so that any one of a distortion correction process of the captured image data and curvature adjustment of a curvature variable display panel in which a curvature of a display surface is variable, based on the distortion degree information.
